(19) United States
(12) Patent Application Publication
(10) Pub. No.: US 2025/0189090 A1
(43) Pub. Date: Jun. 12, 2025

(54) VEHICLE LAMP FITTING

(71) Applicant: STANLEY ELECTRIC CO., LTD., Meguro-ku, Tokyo (JP)

(72) Inventors: Shoichi YAMAGISHI, Tokyo (JP); Tadahiro OTA, Tokyo (JP)

(73) Assignee: STANLEY ELECTRIC CO., LTD., Meguro-ku, Tokyo (JP)

(21) Appl. No.: 18/845,465

(22) PCT Filed: Feb. 28, 2023
(86) PCT No.: PCT/JP2023/007236

§ 371 Date: Sep. 10, 2024

(30) Foreign Application Priority Data
Mar. 11, 2022 (JP) 2022-038406

(51) Int. Cl. F21S 41/141; F21S 41/20; F21S 43/14; F21S 43/20

(52) U.S. Cl. CPC F21S 41/141; F21S 41/285; F21S 43/14; F21S 43/255

(57) ABSTRACT

A vehicle lamp includes a first semiconductor light emitting element having an emission peak wavelength between 470 nm and 520 nm, a second semiconductor light emitting element having an emission peak wavelength between 580 nm and 600 nm, and a red cover portion that faces the first semiconductor light emitting element and the second semiconductor light emitting element. The red cover portion transmits light from the first semiconductor light emitting element, light from the second semiconductor light emitting element, and red light with respective predetermined transmittances. The first semiconductor light emitting element and the second semiconductor light emitting element emit light, and white light is emitted from the red cover portion.

### TECHNICAL FIELD

The present invention relates to a vehicle lamp.

### BACKGROUND ART

Examples of the vehicle lamp include a rear combination lamp. Here, such a rear combination lamp includes a brake light such as a stop lamp or a brake lamp, a direction indicator such as a turn signal lamp or a blinker, a tail lamp, and a backup lamp. Further, the rear combination lamp includes a housing and a cover portion (for example, an outer lens) that covers the front surface side (the vehicle rear side) of the housing. Further, the cover portion of the rear combination lamp is provided with a red light emitting region for a brake light and a tail lamp, an orange (amber) light emitting region for a direction indicator, and a white light emitting region for a backup lamp.

Such a cover portion having the light emitting regions of different colors as described above is produced by, for example, bonding a plurality of plate material parts corresponding to respective regions, or performing multi-color molding (for example, two-color molding) a cover base portion corresponding to the red light emitting region and a remaining transparent resin portion.

However, when the cover portion is produced by such a method, there arise problems such as an increase in the number of assembly steps due to an increase in the number of plate-like parts corresponding to the respective regions, and the need for a complicated metal mold for molding the cover portion. Furthermore, since the color of the cover base portion and the color of the transparent resin portion in the cover portion are different from each other, such a cover portion is not preferable in terms of design. Patent Literature 1 mentioned below discloses an invention for solving such problems.

### CITATION LIST

### Patent Literature

Patent Literature 1: Japanese Patent No. 6769449

### SUMMARY OF INVENTION

### Technical Problem

The invention disclosed in Patent Literature 1 relates to an illumination device that includes: a first light emitting element having an emission peak wavelength between 400 nm and 510 nm; a first fluorescent material provided at a position where light emitted from the first light emitting element is incident, the first fluorescent material having an emission peak wavelength between 485 nm and 700 nm; and a red color filter having a light transmittance of 80% or more at 600 nm to 730 nm and a light transmittance of 3% to 50% at 410 nm to 480 nm, wherein the red color filter is provided at a position where the first light emitted from the first fluorescent material is incident and the red color filter transmits part of the first light. Here, the illumination device emits white light that has been passed through the color filter.

However, referring to FIG. 5 of Patent Literature 1, the transmittance of the light at 410 nm to 480 nm in the red color filter (red cover portion) is relatively high, while the transmittance of light at 500 nm to 600 nm is low. Therefore, when the first light emitting element is turned off, it is considered that a section corresponding to the white light emitting region of the red cover portion exhibits a pinkish red color.

Further, the invention disclosed in Patent Literature 1 utilizes illuminating light from the first fluorescent material. However, the illuminating light from the first fluorescent material includes light with a broad wavelength range ranging from blue to orange. Therefore, the wavelength range of the illuminating light from the first fluorescent material overlaps with the region where the transmittance of the red cover portion is low, and as a result, the light that is derived from the first fluorescent material and is emitted to the outside of the red cover portion is reduced. In this case, light with a color different from the designed white light may be emitted from the red cover portion.

In view of the above-mentioned problems, it is an object to provide a vehicle lamp in which a red color similar to a general red cover portion (for example, a general outer lens colored in red) is exhibited when the light emitting elements are turned off and with which white light is emitted from the red cover portion when the light emitting elements emit light.

### Solution to Problem

In order to solve the above-described problems, a vehicle lamp according to the present invention includes:
a first semiconductor light emitting element having an emission peak wavelength between 470 nm and 520 nm;
a second semiconductor light emitting element having an emission peak wavelength between 580 nm and 600 nm; and
a red cover portion that faces the first semiconductor light emitting element and the second semiconductor light emitting element.

Herein, the red cover portion transmits light from the first semiconductor light emitting element, light from the second semiconductor light emitting element, and red light with respective predetermined transmittances, and
the first semiconductor light emitting element and the second semiconductor light emitting element emit light, and white light is emitted from the red cover portion.

According to this aspect of the present invention, a transmitted light component that is derived from the second semiconductor light emitting element and has a wavelength range (half width) narrower than that emitted from a fluorescent material is utilized, and a red cover portion that transmits light from the first semiconductor light emitting element, light from the second semiconductor light emitting element, and red light with the respective predetermined transmittances is utilized. Thus, when the first semiconductor light emitting element and the second semiconductor light emitting element emit light, white light can be emitted from the red cover portion. When the first semiconductor light emitting element and the second semiconductor light emitting element are turned off, red color similar to that of a general red cover portion is exhibited from the red cover portion of the present invention.

Further, in the vehicle lamp according to the present invention,
it is preferable that only the second semiconductor light emitting element emit light and that amber light be emitted from the red cover portion.

According to this aspect of the present invention, it is possible to obtain emitted light of different colors in a case where both the first semiconductor light emitting element and the second semiconductor light emitting element are caused to emit light and in a case where only the second semiconductor light emitting element is caused to emit light. That is, different lamp functions can be provided by changing the combination of semiconductor elements that emit light.

Further, in the vehicle lamp according to the present invention,
it is preferable that the chromaticity range of the red cover portion satisfy both the following conditions 1 and 2 according to the chromaticity coordinates of JIS Z8701.

$$y \leq 0.38 \qquad ( Condition 1 )$$

$$y \geq 0.94 - x \qquad ( Condition 2 )$$

According to this aspect of the present invention, when the first semiconductor light emitting element and the second semiconductor light emitting element are turned off, the red cover portion exhibits a red color similar to that of a general red cover, although the transmittances of various types of light are adjusted so as to obtain white light.

Further, in the vehicle lamp according to the present invention,
it is preferable that the intensity of the transmitted light component that has been emitted from the second semiconductor light emitting element and passed through the red cover portion be 4 or less times the intensity of the transmitted light component that has been emitted from the first semiconductor light emitting element and passed through the red cover portion.

According to this aspect of the present invention, for example, white light that can comply with lamp chromaticity regulations such as SAE J578C can be obtained.

Further, in the vehicle lamp according to the present invention, it is preferable that
in the red cover portion,
the transmittance of the light from the first semiconductor light emitting element be 5% to 40%,
the transmittance of the light from the second semiconductor light emitting element be 10% to 60%, and
the transmittance of the red light be 80% or more.

According to this aspect of the present invention, since each transmittance in the red cover portion is adjusted so as to satisfy the above-described conditions, it is possible to obtain clear white light from the light emission of the first semiconductor light emitting element and the second semiconductor light emitting element.

### Advantageous Effects of Invention

According to the present invention, it is possible to provide a vehicle lamp in which a red color similar to a general red cover portion (for example, a general outer lens colored in red) is exhibited and with which white light is emitted from the red cover portion when the light emitting elements emit light.

### BRIEF DESCRIPTION OF DRAWINGS

FIG. 1 is a schematic view of a vehicle lamp according to an embodiment of the present invention.

FIG. 2 is a perspective view of a light source unit in the present embodiment.

FIG. 3 is a graph showing a transmission spectrum of a red cover portion in the present embodiment.

FIG. 4 is a part of a chromaticity coordinate diagram (JIS Z8701) in which the chromaticity of light emitted from the vehicle lamp of the present embodiment is plotted.

FIG. 5 includes illustrations that shows the functioning of the light source unit when a first semiconductor light emitting element and a second semiconductor light emitting element in the present embodiment emit light.

FIG. 6 is a graph for comparing the light intensity of the light that is derived from the first semiconductor light emitting element (transmitted light) with that of the light that is derived from the second semiconductor light emitting element (transmitted light) in the present embodiment.

FIG. 7 includes illustrations that shows the functioning of the light source unit 10 when only the second semiconductor light emitting element in the present embodiment emits light.

### DESCRIPTION OF EMBODIMENTS

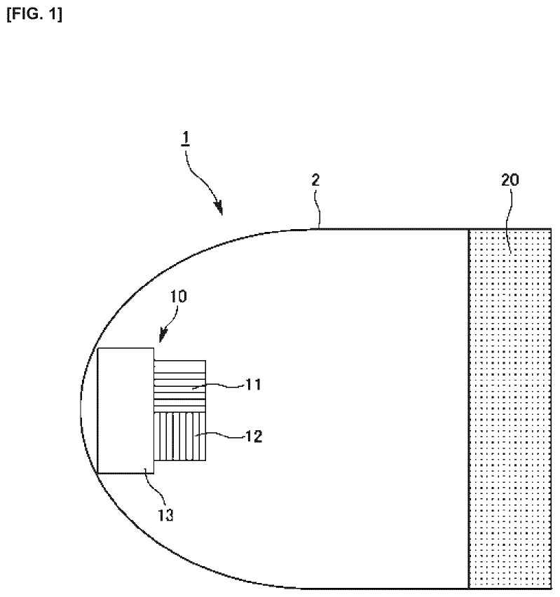

Hereinafter, a vehicle lamp according to an embodiment of the present invention will be described in detail with reference to the drawings. First, a vehicle lamp 1 and a light source unit 10 according to the present embodiment will be described with reference to FIGS. 1 to 4.

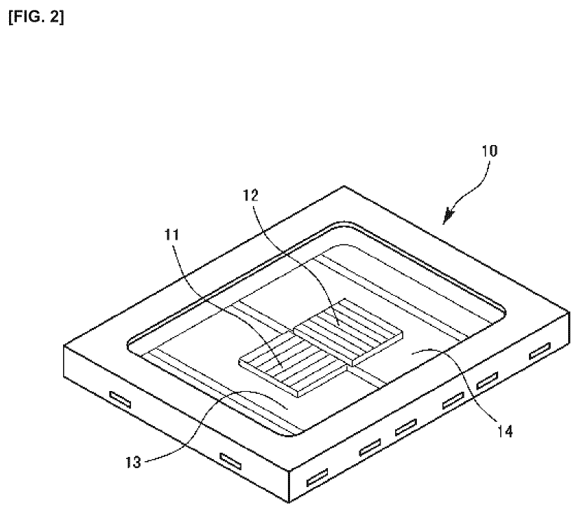

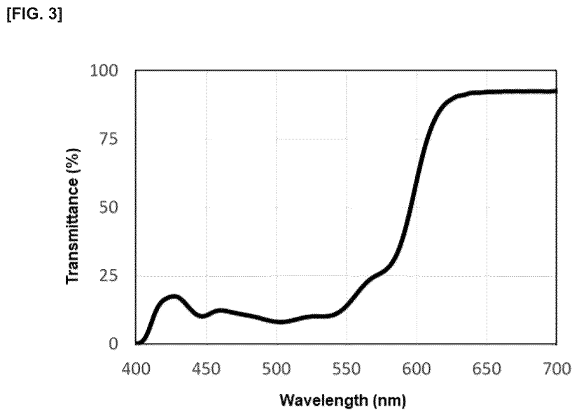

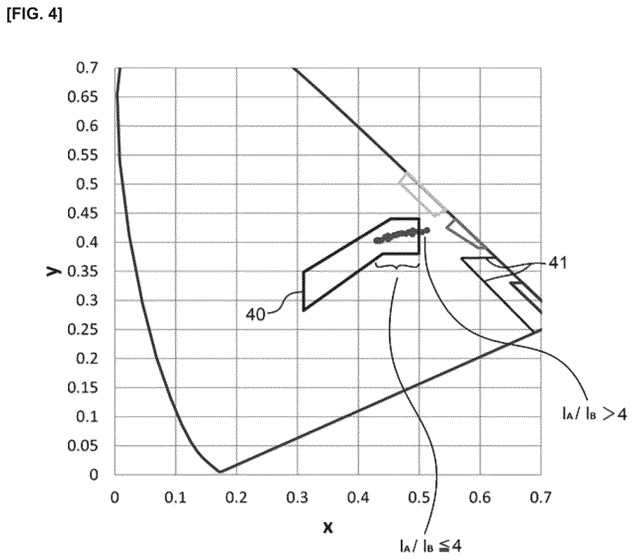

Here, FIG. 1 is a schematic view illustrating a schematic configuration of the vehicle lamp 1. FIG. 2 is a perspective view of the light source unit 10 included in the vehicle lamp 1. FIG. 3 is a graph showing a transmission spectrum of a red cover portion included in the vehicle lamp 1. FIG. 4 is a part of a chromaticity coordinate diagram (JIS Z8701) in which the chromaticity of light emitted from the vehicle lamp 1 of the present embodiment is plotted.

The vehicle lamp 1 of the present embodiment is, for example, a rear combination lamp to be attached to the rear portion of a vehicle body of an automobile. As illustrated in FIG. 1, the vehicle lamp 1 includes a lamp housing 2, a light source unit 10, a red cover portion 20 (outer lens), and the like.

The light source unit 10 is housed in the lamp housing 2. The red cover portion 20 covers a front opening portion of the lamp housing 2 (an opening portion located on the vehicle rear side of the lamp housing). As a result, a lamp chamber 3 that accommodates the light source unit 10 and the like is defined. Further, the red cover portion 20 faces the light source unit 10.

Next, as shown in FIG. 2, the light source unit 10 of the present embodiment includes a first semiconductor light emitting element 11 having an emission peak wavelength between 470 nm and 520 nm, a second semiconductor light emitting element 12 having an emission peak wavelength between 580 nm and 600 nm, a substrate 13 on which the first semiconductor light emitting element 11 and the second semiconductor light emitting element 12 are mounted, and the like. Although not particularly limited, it is preferable that the light source unit 10 additionally include a transparent sealing resin 14 that covers the first semiconductor light emitting element 11 and the second semiconductor light emitting element 12.

The first semiconductor light emitting element 11 in the present embodiment is an LED (Light Emitting Diode) having an emission peak wavelength of about 490 nm. More specifically, the first semiconductor light emitting element 11 in the present embodiment is made of an InGaN-based semiconductor and emits blue-green light. However, the present invention is not limited to this, as long as the light emitting element has an emission peak wavelength between 470 nm and 520 nm.

In addition, the second semiconductor light emitting element 12 in the present embodiment is an LED having an emission peak wavelength of about 590 nm. More specifically, the second semiconductor light emitting element 12 in the present embodiment is made of an AlGaInP-based semiconductor and emits amber light. However, the present invention is not limited to this, as long as the light emitting element has an emission peak wavelength between 580 nm and 600 nm.

The first semiconductor light emitting element 11 and the second semiconductor light emitting element 12 in the present embodiment are LEDs, but they may be different semiconductor light emitting elements (for example, laser diodes or the like) having the above-described respective emission peak wavelengths, or may be other semiconductor light emitting elements.

Next, the red cover portion 20 is formed of a transparent resin plate colored with a red pigment. Here, the type of red pigment of the red cover portion 20 is not particularly limited. Examples of the type of red pigment include azo compounds, cyanine compounds, perylene compounds, and dioxazine compounds. The material of the transparent resin plate colored with the red pigment is not particularly limited either. Examples of the transparent resin plate include an acrylic resin and a polycarbonate resin.

Examples of the transmission characteristics of the red cover portion 20 include those corresponding to the transmission spectrum shown in FIG. 3. More specifically, examples of the transmission characteristics of the red cover portion 20 include those satisfying all of the following conditions (3) to (5).
(Condition 3): For example, the transmittance of blue light to green blue light (blue-green light) at wavelengths between 400 nm and 550 nm is 5% to 40%.
(Condition 4): For example, the transmittance of amber light at wavelengths between 580 nm and 600 nm is 10% to 60%.
(Condition 5): For example, the transmittance of red light at the wavelength between 620 nm and 730 nm is 80% or more.

That is, the red cover portion 20 transmits the red component of an external light with the transmittance stated in the condition 5. At the same time, the red cover portion 20 also transmits the illuminating light from the first semiconductor light emitting element 11 and the illuminating light from the second semiconductor light emitting element 12 with the transmittances stated in the conditions 3 and 4.

Thus, when light is emitted from the first semiconductor light emitting element 11 and the second semiconductor light emitting element 12, for example, white light corresponding to the chromaticity range in or near a frame 40 (white light regulated by the US lamp chromaticity law, SAE J578C) in the chromaticity coordinates of FIG. 4 is emitted from the red covering portion 20.

However, at the time of light emission of the first semiconductor light emitting element 11 and the second semiconductor light emitting element 12, the transmission characteristics of the red cover portion 20 is not limited to the above-described ones, as long as white light that has a chromaticity range satisfying, for example, 0.500≥x≥0.310, y≥0.150+0.640x, y≥0.050+0.750x, and 0.440≥y≥0.382 in the chromaticity coordinates based on JIS Z8701, is emitted from the red cover portion 20.

Further, it is preferable that the red cover portion 20 in the present embodiment fall within the chromaticity range that satisfies both the following conditions 1 and 2 according to the chromaticity coordinates of JIS Z8701.

$$y \leq 0.38 \qquad Condition 1$$

$$y \geq 0.94 - x \qquad Condition 2$$

When the chromaticity range of the red cover portion 20 satisfies the conditions 1 and 2 described above (the region surrounded by the line segment 41 in FIG. 4), the entire red cover portion exhibits a red color similar to that of a general red cover when the first semiconductor light emitting element 11 and the second semiconductor light emitting element 12 are turned off.

According to the present embodiment, a transmitted light component that is derived from the second semiconductor light emitting element 12 and has a wavelength range (half width) narrower than that emitted from a fluorescent material is utilized, and the red cover portion 20 that transmits light from the first semiconductor light emitting element 11, light from the second semiconductor light emitting element 12, and red light with the respective predetermined transmittances is utilized. Thus, when both the light emitting elements emit light, white light is emitted from the red cover portion 20.

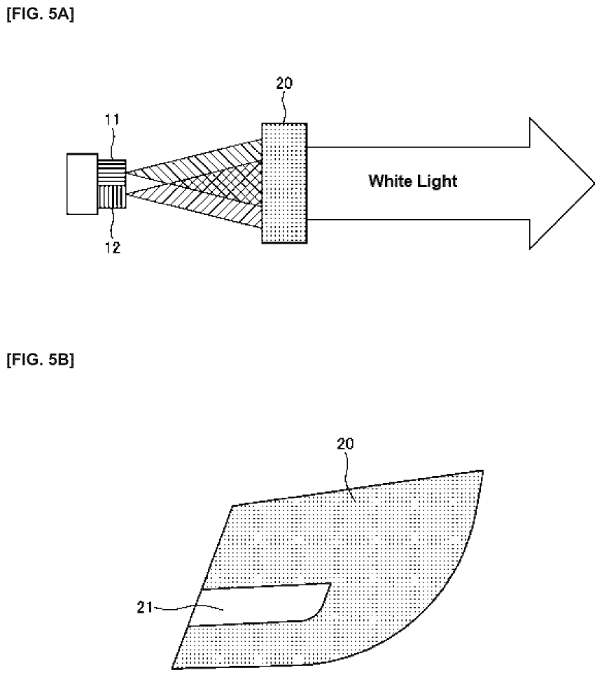

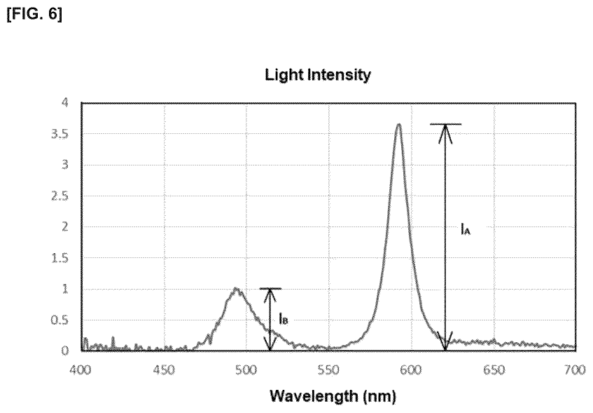

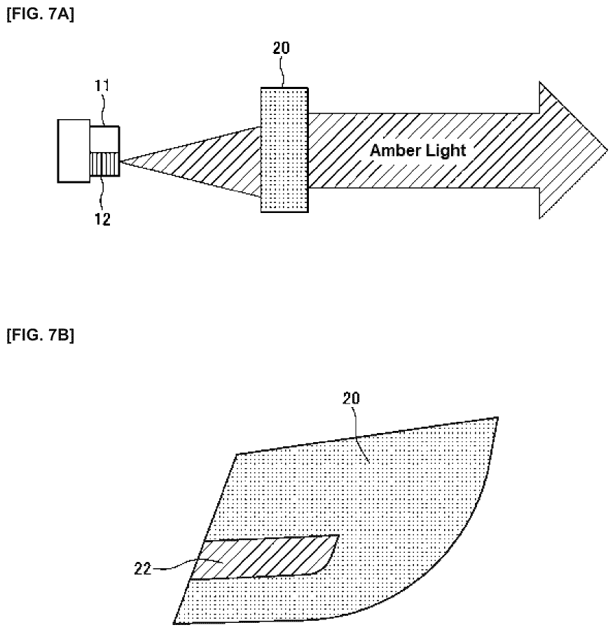

Next, the functioning of the vehicle lamp 1 according to the present embodiment will be described with reference to FIGS. 5 to 7. Here, FIG. 5 includes illustrations that shows the functioning of the light source unit 10 when the first semiconductor light emitting element 11 and the second semiconductor light emitting element 12 emit light. FIG. 6 is a graph for comparing the light intensity of the light that is derived from the first semiconductor light emitting element 11 (transmitted light) with that of the light that is derived from the second semiconductor light emitting element 12 (transmitted light). FIG. 7 includes illustrations that shows the functioning of the light source unit 10 when only the second semiconductor light emitting element 12 emits light.

As illustrated in FIG. 5(a), when the first semiconductor light emitting element 11 and the second semiconductor light emitting element 12 are caused to emit light, the illuminating light from both the first and second semiconductor light emitting elements is directed toward the red cover portion 20. As described above, the red cover portion 20 transmits the illuminating light from the first semiconductor light emitting element 11 with a transmittance of 5% to 40%, and also transmits the illuminating light from the second semiconductor light emitting element 12 with a transmittance of 10% to 60%. Further, for example, red light that is derived from external light is transmitted through the red cover portion 20.

As a result, the transmitted light component derived from the first semiconductor light emitting element 11, the transmitted light component derived from the second semiconductor light emitting element 12, and the red transmitted light component derived from the external light are emitted to the outside of the red cover portion 20. As a result, white light as the mixed light of these transmitted light components is emitted to the outside of the red cover portion 20. In the present embodiment, white light emitted from the red cover portion 20 is used as a backup lamp (FIG. 5(b)). Note that reference numeral 21 in FIG. 5(b) corresponds to a white light emitting region in the red cover portion 20.

Here, the light intensity IA of the transmitted light (emitted light) component derived from the second semiconductor light emitting element 12 that has been transmitted through the red covering portion 20 is preferably not more than 4 times the light intensity IB of the transmitted light (emitted light) component derived from the first semiconductor light emitting element 11.

When both light intensities satisfy the above-mentioned conditions, as shown in FIG. 4, for example, white light satisfying SAE J578C can be obtained (the chromaticity of the light emitted from the red covering portion 20 can be confined within the frame 40 in the chromaticity coordinates of FIG. 4).

Next, as shown in FIG. 7(a), when only the second semiconductor light emitting element 12 emits light, amber light similar to the illuminating light of the second semiconductor light emitting element 12 is emitted from the red cover portion 20 due to the transmission characteristics of the red cover portion 20. In the present embodiment, the amber light emitted from the red cover portion 20 is used as a turn signal lamp. Note that reference numeral 22 in FIG. 7(b) corresponds to an amber light emitting region in the red cover portion 20.

As described above, it is possible to obtain emitted light of different colors in a case where both the first semiconductor light emitting element 11 and the second semiconductor light emitting element 12 are caused to emit light and in a case where only the second semiconductor light emitting element 12 is caused to emit light. That is, different lamp effects can be provided by changing the combination of semiconductor elements that are caused to emit light.

The embodiment of the present invention has been described in detail above. However, the foregoing description is for the purpose of facilitating understanding of the present invention, and is not intended to limit the present invention. The present invention may include changes and improvements without departing from the spirit thereof. The present invention also includes equivalents thereof.

For example, the vehicle lamp 1 may include an inner lens that is interposed between the red cover portion 20 and the first and second semiconductor light emitting elements 11 and 12. Further, the vehicle lamp 1 may include a reflector that distributes the illuminating light from the first semiconductor light emitting element 11 and the second semiconductor light emitting element 12 to the red cover portion 20 side.

Further, the vehicle lamp 1 described above is a rear combination lamp, but may be other types of lamps (for example, a vehicle lid lamp or the like).

### REFERENCE SIGNS LIST

1 . . . vehicle lamp
10 . . . light source unit
11 . . . first semiconductor light emitting element
12 . . . second semiconductor light emitting element
20 . . . red cover portion
   21 . . . white light emitting region
   22 . . . amber light emitting region

1. A vehicle lamp comprising:
a first semiconductor light emitting element having an emission peak wavelength between 470 nm and 520 nm;
a second semiconductor light emitting element having an emission peak wavelength between 580 nm and 600 nm; and
a red cover portion that faces the first semiconductor light emitting element and the second semiconductor light emitting element,
wherein the red cover portion transmits light from the first semiconductor light emitting element, light from the second semiconductor light emitting element, and red light with respective predetermined transmittances such that when the first semiconductor light emitting element and the second semiconductor light emitting element emit light, white light is emitted from the red cover portion.

2. The vehicle lamp according to claim 1, wherein when only the second semiconductor light emitting element emits light, amber light is emitted from the red cover portion.

3. The vehicle lamp according to claim 1, wherein a chromaticity range of the red cover portion satisfies both the following conditions 1 and 2 according to the chromaticity coordinates of JIS Z8701.
$$y \leq 0.38 \qquad ( Condition 1 )$$
$$y \geq 0.94 - x \qquad ( Condition 2 )$$

4. The vehicle lamp according to claim 1, wherein an intensity of a transmitted light component that has been emitted from the second semiconductor light emitting element and passed through the red cover portion is 4 or less times an intensity of a transmitted light component that has been emitted from the first semiconductor light emitting element and passed through the red cover portion.

5. The vehicle lamp according to claim 1, wherein in the red cover portion:
the transmittance of light from the first semiconductor light emitting element is 5% to 40%,
the transmittance of the light from the second semiconductor light emitting element is 10% to 60%, and
the transmittance of the red light is 80% or more.
